(19) United States
(12) Patent Application Publication
(10) Pub. No.: US 2008/0200043 A1
(43) Pub. Date: Aug. 21, 2008

(54) Dual display card connection means

(75) Inventor: Shih-Kun Yeh, Taoyuan Hsieh (TW)

Correspondence Address: TROXELL LAW OFFICE PLLC, SUITE 1404, 5205 LEESBURG PIKE, FALLS CHURCH, VA, 22041, US

(73) Assignee: TENNRICH INTERNATIONAL CORP.

(21) Appl. No.: 11/706,428

(22) Filed: Feb. 15, 2007

(51) Int. Cl. H01R 12/00; A63F 9/24

(52) U.S. Cl. 439/67; 463/45

(57) ABSTRACT

A dual-display card connection means includes two sets of bridges respectively adapted to two display cards, and a flexible flat cable (FFC) connecting two bridges. A bridge terminal is inserted in a bridge connection base to form an information connection between the two display cards. The FFC is bendable to facilitate a flexible connection between the two display cards.

### BACKGROUND OF THE INVENTION

(a) Field of the Invention

The present invention is related to a connection means applied among multiple display cards, and more particularly, to one that facilitates connection between two display cards and copies with limited space of a main unit in a computer.

(b) Description of the Prior Art

Special effects from massive graphic processor efficacy to produce extremely dazzling pictures are commonly seen in 3 dimensions (3D) game software of the current mainstream. Relatively, display card manufacturers keep introducing new products to continuously add new functions and upgrade 3D graphic efficacy. However, a roadmap for the development presents to the consumers a problem that it becomes difficult to command the use and life cycle of the display card. In terms of the development roadmap of the display card alone, a design of multiple Graphic Processing Units on a single display card may upgrade operation efficacy of the display card, other factors including heat dissipation, weight, and even the size of the entire display card must be also taken into consideration.

Entering from a different angle, Graphic Processing Units respective provided on two display cards to perform operation on a 3D game achieves the same higher operation efficacy. For example, there are many motherboards available in the market to support SLI (Scalable Link Interface, permitting expanded connection interface). A similar motherboard to support dual-display card is usually provided with two display card slots in parallel with each other for installation of two single display cards, thus for the user to expand graphic efficacy on the Graphic Processing Units adapted to both display cards in a system to upgrade coordinates operation and color filling speed.

Accordingly, so far a dual-display card platform described above appears to be one of those display card technologies generally acceptable to the consumer. The dual-display card platform not only allows multiple display cards to be effectively integrated into a system for rapid increase of display rate, but also presents an approach that is more capable of complying with the current of parallel structures by taking advantage of load balance. Although current technology is no longer subject to limitations of demanding totally identify display cards and firmware in the past, even to such extent that Scalable Link Interface can be executed without connection to a bridge card connector for information exchange, the optimal efficacy is attained when a bridge card connector module is used to connect both display cards in the SLI in field tests.

Furthermore, the SLI is a technology exclusively designed for PCI Express interface. The spacing between two PCI Express slots disposed in various motherboards generally available in the market to support the SLI is not totally the same; therefore, the connection line between two display cards is preferred to be provided with a feature of allowing folding at a sharp angle while permitting curvature use before being termed as efficient to cope with the insufficient space of a main unit in a computer.

### SUMMARY OF THE INVENTION

The primary purpose of the present invention is to provide a means to facilitate connection between two display cards and to be more capable of coping with the limited space of the main unit in the computer. To achieve the purpose, a flexible flat cable (FFC) is used in the present invention to connect two bridges respective from two display cards.

Wherein, the bridge includes a bridge terminal fixed to a display card and a bridge base fixed to one side of the FFC. While taking advantage of connection between the bridge terminal inserted to the bridge base to achieve information connection between two display cards, the FFC for being flexible and bendable facilitates the connection between two display cards; and the FFC gives feature of being folded at sharp angle to be more efficient in coping with the limited space of the main unit in the computer. Furthermore, FFC is offered as lowest cost thus to help save installation cost of the connection means of the present invention.

### BRIEF DESCRIPTION OF THE DRAWINGS

FIG. 1 is a schematic view showing an operation status of a connection means between two display cards of the present invention.

FIG. 2 is an exploded view showing a construction of the connection means and two display cards of the present invention.

### DETAILED DESCRIPTION OF THE PREFERRED EMBODIMENTS

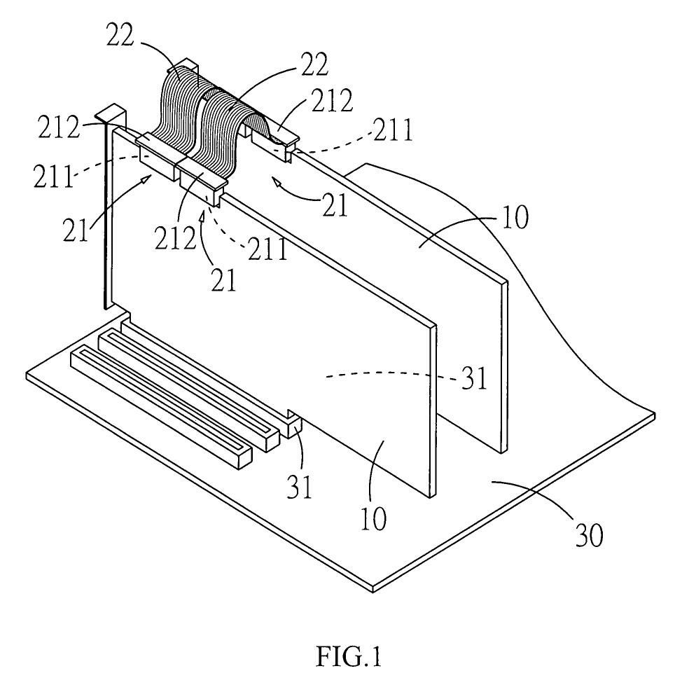

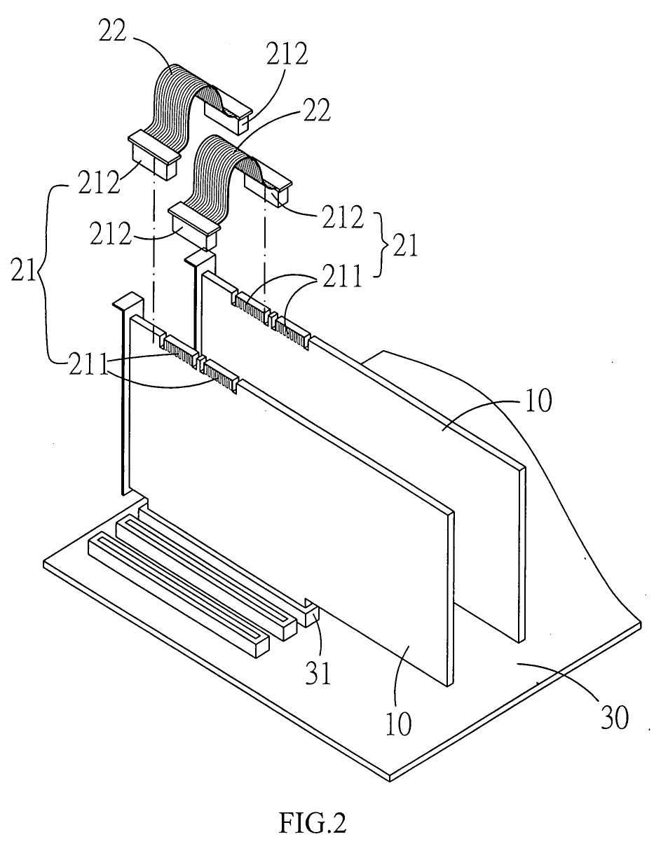

Referring to FIGS. 1 and 2 for a preferred embodiment of the present invention, a motherboard 30 applied in the present invention is constructed with two display card slots 31 and each slot 31 is inserted with a single display card 10 to constitute a dual-display card system. A connection means of the present invention providing signal connection between two single display cards 10 in the dual-display card system is essentially comprised of multiple, and two in the preferred embodiment, sets of bridge 21 respectively adapted to two display cards 10, and one or a plurality of Flexible Flat Cable (FFC) 22 connecting two bridges 21.

Wherein each set of bridge 21 includes a bridge terminal 211 fixed to the display card 10, and a bridge base 212 fixed to the FCC 22; and the FCC 22 functions as a signal transmission line connecting both display cards 10.

Accordingly, the connection means provides information connection between two display cards 10 simply by taking advantage of plugging to secure both sets of respectively bridge terminals 211 and both bridge connection bases 212. In practice, FFC 22 is selected as the signal transmission line between two display cards 10 because that FCC while providing good flexibility and allowing to be bent to facilitate the connection between two display cards is cheaper for being strictly a flexible cable in comparison with a Flexible Printed Circuit (FPC) that gives similar circuit transmission function thus to reduce the production cost of the connection means of the present invention. Furthermore, the FFC may be folded at a sharp angle to make it more capable of coping with the limited main unit space in a computer and is unlikely to break or damage the line in the course of plug in/plug out between the bridge terminal 211 and the bridge connection base 212. Therefore, the connection means of the present invention is better meeting the voluntary upgrading and expanding needs of the consumer.

The present invention by a design of using the FFC to connect between two bridges on two display cards does achieve the purpose of production cost reduction, facilitate the connection between two display cards, better competent in coping with the limited space of the main unit in a computer, and preventing damaged line during plug in/plug out between the bridge terminal and the bridge connection base.

The prevent invention provides an improved structure of a connection means for a dual-display card, and the application for a utility patent is duly filed accordingly. However, it is to be noted that the preferred embodiments disclosed in the specification and the accompanying drawings are not limiting the present invention; and that any construction, installation, or characteristics that is same or similar to that of the present invention by those who are familiar with the art of the present invention should fall within the scope of the purposes and claims of the present invention.

1.-2. (canceled)

3. A dual-display connection structure, comprising:
a first bridge including a first flexible flat cable (FFC) having a bridge base fixed to each end of the FFC, wherein the bridge bases of the first bridge are adapted to engage first bridge terminals with one first bridge terminal being located on a first display card and another first bridge terminal being located on a second display card; and
a second bridge including a second flexible flat cable (FFC) having a bridge base fixed to each end of the second FFC, wherein the bridge bases of the second bridge are adapted to engage second bridge terminals with one second bridge terminal being located on the first display card and another second bridge terminal being located on a second display card,
wherein the first and second bridges are adapted to serve as a signal transmission circuit between the first and second display cards.
